(19) United States
(12) Patent Application Publication
(10) Pub. No.: US 2014/0316045 A1
(43) Pub. Date: Oct. 23, 2014

(54) Silicone Resins

(71) Applicant: Dow Corning Corporation, Midland, MI (US)

(72) Inventors: Mert Kilinc, Brussels (BE); David Pierre, BXL (Watermael-Boit) (BE); Vincent Rerat, Tubize (BE)

(73) Assignee: Dow Corning Corporation, Midland, MI (US)

(21) Appl. No.: 14/358,355

(22) PCT Filed: Nov. 14, 2012
(86) PCT No.: PCT/EP2012/072629

§ 371 Date: May 15, 2014

(30) Foreign Application Priority Data
Nov. 17, 2011 (GB) GB 1119817.3
Nov. 14, 2012 (EP) PCT/EP2012/072629

(51) Int. Cl. C08G 77/30; C09D 183/08; C08L 83/08

(52) U.S. Cl. CPC C08G 77/30; C08L 83/08; C09D 183/08
USPC 524/387; 528/30; 525/474; 524/500; 524/588; 524/858; 524/405; 524/433; 524/430; 524/416; 524/404; 524/445; 524/414; 524/451; 524/418; 524/503

(57) ABSTRACT

The invention relates to silicone resins. It also relates to the preparation of organopolysiloxanes and to their use in a thermoplastic or thermosetting organic polymer or thermoplastic blends or thermosetting organic polymer blends or rubbers or thermoplastic/rubbers blends composition to reduce the flammability or enhance scratch and/or abrasion resistance of the organic polymer composition. It further relates to coatings made of such silicone resins for scratch resistance enhancement or flame retardant properties.

The invention relates to silicone resins. It also relates to the preparation of organopolysiloxanes and to their use in a thermoplastic or thermosetting organic polymer or thermoplastic blends or thermosetting organic polymer blends or rubbers or thermoplastic/rubbers blends composition to reduce the flammability or enhance scratch and/or abrasion resistance of the organic polymer composition. It further relates to coatings made of such silicone resins for scratch resistance enhancement or flame retardant properties.

The fire resistance of a material can be enhanced for example by providing flame retardant properties to the material. Abrasion typically happens when a surface is rubbed off or worn off by friction whereas scratch is a mark or incision made on a surface by scratching.

Development of efficient halogen-free flame retardant additives for thermoplastics and thermosets is still a great need for many industrial applications. New upcoming regulation such as European harmonized EN45545 norm as well as growing green pressure are pushing the market to develop new effective halogen-free solutions. In the recent years, many researches were made in the field of halogen-free flame retardant. Silicone-based materials are of particular interest in this field.

EP2093264 describes a silicone resin formed from methyltrimethoxysiloxane oligomer and 3-mercaptopropyltrimethoxysilane.

CN101168620 describes a fire retardant silicone rubber formed from a composition containing polysiloxane and alkyldisilazane.

CN101023120 describes a substituted organopolysiloxane which may contain sulfur.

EP2184310 describes a coating composition comprising an organopolysiloxane having a triazine-thiol radical which is coated onto a film substrate to form a gas barrier layer having improved properties including gas barrier, adhesion, flexibility, flexing resistance, and transparency.

EP2093247 describes a triazinethiol and alkenyl-containing organopolysiloxane.

CN1544510 describes polysiloxane with sulphonyl indole chromophore side group, its preparation and application.

U.S. Pat. No. 6,602,938 describes a flame resistant polycarbonate resin composition containing a silicone compound with an alkali metal salt of an aromatic sulfonic acid.

However, even if the before mentioned patent describes halogen-free silicone, it shows only limited flame retardant performances narrowed down to anti-dripping effect following UL-94 test.

In view of the state of the art, it is the object of the present invention to provide a flame retardant additive system based on strong synergy based on phosphorylated sulfur containing silicone technology which is cheap, easy to process and with high thermal and moisture stability making them suitable for applications where high processing temperature are required. Moreover, it is expected that the additives presented in the following patent are suitable to reach new norms requirements and particularly efficient at reducing fumes emission of the final compound.

The invention provides a silicone resin comprising a silicone resin comprising

a. at least one group containing sulfur
b. at least one group which contains phosphorus and optionally nitrogen.

While silicone structures are known, no prior art suggest a silicone structure containing phosphorous or nitrogen in addition to sulfur and demonstrating unexpected flame retardant performances synergism compared to their non phosphorus or nitrogen containing counterpart.

We have found that such structures may form resins having a high degree of flame retardancy. We have also found that such structures were of particular heat stability compared to their non phosphorus containing counterparts, making them suitable for applications where very high processing temperatures are required such as in polycarbonate or polyamide.

The silicone resin composition defined in the present patent can also be obtained through any physical combination of phosphorylated siloxane with phosphorylated sulfur containing siloxane, phosphorylated siloxane with sulfur containing siloxane or phosphorylated sulfur-containing siloxane with siloxane.

The silicone resin of the invention contains sulfur. Sulfur can be in the form of S at oxidation state of −2 to +6, i.e. −2, −1, 1, 2, 3, 4, 5, 6. It is preferably integrated into T units.

Preferably the silicone resin of the invention comprises at least one P-containing group. The presence of a P-containing group is particularly efficient to provide flame retardancy properties to the resin and P-containing compounds are readily available to being used as raw materials able to form the resin.

The silicone resin preferably contains T units; D; M and/or Q units. The resin contains polyorganosiloxanes, also known as silicones, generally comprising repeating siloxane units selected from R₃SiO_{1/2} (M units), R₂SiO_{2/2} (D units), RSiO_{3/2} (T units) and SiO_{4/2} (Q units), in which each R represents an organic group or hydrogen or a hydroxyl group. Branched silicone resins contain T and/or Q units, optionally in combination with M′ and/or D units, are preferred.

In the branched silicone resins of the invention, at least 25% of the siloxane units are preferably T and/or Q units. More preferably, at least 75% of the siloxane units in the branched silicone resin are T and/or Q units.

Preferably, the resin contains at least one phosphorus containing group present in a M unit of the formula RPR2SiO1/2 and/or D unit of the formula RPRSiO2/2 and/or a T unit of the formula R_{P}SiO3/2, where R_{P} is an alkyl, cycloalkyl, alkenyl, alkynyl or aryl group having 1 to 20 carbon atoms containing a phosphorus substituent. This phosphorus substituent can be at an oxidation state of −3, −1, +1, +3 or +5, preferably −3, +3 or +5. It can be phosphine and/or phosphine oxide and/or phosphinate and/or phosphinite and/or phosphonite and/or phosphite, and/or phosphonate and/or phosphate substituent, and each group R is independently an alkyl, cycloalkyl, alkenyl, alkynyl or aryl group having 1 to 20 carbon atoms.

More preferably, the phosphorus containing group R_{P} is an organic group. It is preferably present in a T unit of the formula R_{P}SiO3/2.

Preferably, the group R_{P} has the formula

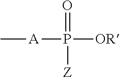

where A is a divalent hydrocarbon group having 1 to 20 carbon atoms or an —OR* group, R* is a hydrogen, alkyl or aryl group having 1 to 12 carbon atoms, and Z is a group of the formula —OR* or an alkyl, cycloalkyl, alkenyl, alkynyl or aryl group having 1 to 20 carbon atoms. When 2 —OR* groups are present on the P group, they can be different.

The phosphinate substituent can comprise a 9,10 dihydro-9-oxa-10-phosphaphenanthrene-10-oxide group, sometimes known as DOPO group. Therefore, preferably the group R_{P} has the formula

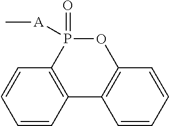

where A is a divalent group having 1 to 20 carbon atoms, for example a hydrocarbon group forming 2-DOPO-ethyl or 3-DOPO-propyl. The divalent group can also be an aryl containing group for example forming DOPO-Hydroquinone.

Alternatively, the P-organic group can be

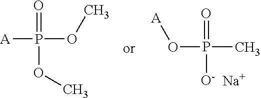

where A is the linking group to the silicon part. A can be rather a simple or branched alkyl, alkenyl (unsaturated), simple or substituted arylalkyl or aryl group.

In some preferred embodiments, the branched silicone resin of the invention preferably contains at least one organic nitrogen-containing group present in a T unit of the formula R_{N}SiO_{3/2}, where R_{N} is an alkyl, cycloalkyl, alkenyl, alkynyl or aryl group having 1 to 20 carbon atoms containing a organic nitrogen substituent.

In one preferred type of resin according to the invention the organic group containing nitrogen is a heterocyclic group present as a group of the formula

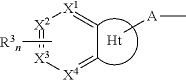

where X¹, X², X³ and X⁴ independently represent a CH group or a N atom and form a benzene, pyridine, pyridazine, pyrazine, pyrimidine or triazine aromatic ring; Ht represents a heterocyclic ring fused to the aromatic ring and comprising 2 to 8 carbon atoms, 1 to 4 nitrogen atoms and optionally 1 or 2 oxygen and/or sulphur atoms; A represents a divalent organic linkage having 1 to 20 carbon atoms bonded to a nitrogen atom of the heterocyclic ring; the heterocyclic ring can optionally have one or more substituent groups selected from alkyl, substituted alkyl, cycloalkyl, alkenyl, alkynyl, aryl and substituted aryl groups having 1 to 12 carbon atoms and amino, nitrile, amido and imido groups; and R³ₙ, with n=0-4, represents an alkyl, substituted alkyl, cycloalkyl, alkenyl, alkynyl, aryl or substituted aryl group having 1 to 40 carbon atoms, or an amino, nitrile, amido or imido group or a carboxylate —C(═O)—O—R⁴, oxycarbonyl —O—(C═O)—R⁴, carbonyl —C(═O)—R⁴, or an oxy —O—R⁴ substituted group with R⁴ representing hydrogen or an alkyl, cycloalkyl, alkenyl, alkynyl, aryl, or substituted aryl groups having 1 to 40 carbon atoms, substituted on one or more positions of the aromatic ring, or two groups R³ can be joined to form a ring system comprising at least one carbocyclic or heterocyclic ring fused to the aromatic ring.

The heterocyclic ring Ht is preferably not a fully aromatic ring, i.e. it is preferably not a pyridine, pyridazine, pyrazine, pyrimidine or triazine aromatic ring. The heterocyclic ring Ht can for example be an oxazine, pyrrole, pyrroline, imidazole, imidazoline, thiazole, thiazoline, oxazole, oxazoline, isoxazole or pyrazole ring. Examples of preferred heterocyclic ring systems include benzoxazine, indole, benzimidazole, benzothiazole and benzoxazole. In some preferred resins the heterocyclic ring is an oxazine ring so that R_{N} is a group of the formula.

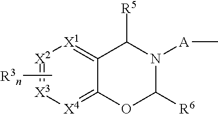

where X¹, X², X³ and X⁴, A, R³ and n are defined as above and R⁵ and R⁶ each represent hydrogen, an alkyl, substituted alkyl, cycloalkyl, alkenyl, alkynyl, aryl or substituted aryl group having 1 to 12 carbon atoms, or an amino or nitrile group. The group can for example be a benzoxazine group of the formula

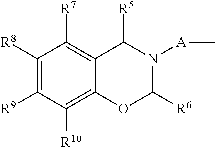

where R⁷, R⁸, R⁹ and R¹⁰ each represent hydrogen, an alkyl, substituted alkyl, cycloalkyl, alkenyl, alkynyl, aryl or substituted aryl group having 1 to 40 carbon atoms, or an amino, nitrile, amido or imido group or a carboxylate —C(═O)—O—R⁴, oxycarbonyl —O—(C═O)—R⁴, carbonyl —C(═O)—R⁴, or an oxy —O—R⁴ substituted group with R⁴ representing hydrogen or an alkyl, cycloalkyl, alkenyl, alkynyl, aryl, or substituted aryl groups having 1 to 40 carbon atoms, or R⁷ and R⁸, R⁸ and R⁹ or R⁹ and R¹⁰ can each be joined to form a ring system comprising at least one carbocyclic or heterocyclic ring fused to the benzene ring.

The oxazine or other heterocyclic ring Ht can alternatively be bonded to a pyridine ring to form a heterocyclic group of the formula

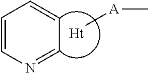

The benzene, pyridine, pyridazine, pyrazine or triazine aromatic ring can be annelated to a ring system comprising at least one carbocyclic or heterocyclic ring to form an extended ring system enlarging the pi-electron conjugation. A benzene ring can for example be annelated to another benzene ring to form a ring system containing a naphthanene moiety

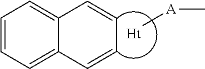

such as a naphthoxazine group, or can be annelated to a pyridine ring to form a ring system
containing a quinoline moiety.

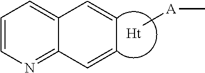

A pyridine ring can for example be annelated to a benzene ring to form a ring system containing a quinoline moiety in which the heterocyclic ring Ht, for example an oxazine ring, is fused to the pyridine ring

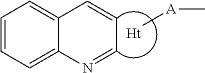

The aromatic ring can be annelated to a quinone ring to form a naphthoquinoid or anthraquinoid structure. In an alkoxysilane of the formula

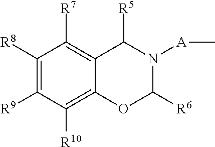

the groups R⁸ and R⁹, R⁷ and R⁸, or R⁹ and R¹⁰ can form an annelated ring of naphthoquinoid or anthraquinoid structure. Such ring systems containing carbonyl groups may form resins having improved solubility in organic solvents, allowing easier application to polymer compositions.

The organic group R_{N} containing nitrogen can alternatively comprise an aminoalkyl or aminoaryl group containing 1 to 20 carbon atoms and 1 to 3 nitrogen atoms bonded to a silicon atom of the silicone resin, for example —(CH₂)₃NH₂, —(CH₂)₄NH₂, —(CH₂)₃NH(CH₂)₂NH₂, —CH₂CH(CH₃)CH₂NH₂, —CH₂CH(CH₃)CH₂NH(CH₂)₂NH₂, —(CH₂)₃NHCH₂CH₂NH(CH₂)₂NH₂, —CH₂CH(CH₃)CH₂NH(CH₂)3NH₂, —(CH₂)₃NH(CH₂)₄NH₂ or —(CH₂)₃O(CH₂)₂NH₂, or —(CH₂)₃NHC₆H₄, —(CH₂)₃NH(CH₂)₂NHC₆H₄, —(CH₂)₃NHCH₃, —(CH₂)₃N(C₆H₄)₂.

Preferably, the molar ratio of Sulfur atom to Si atom of the silicone resin ranges from 0.01:1 to 2:1.

The invention further provides a method for the preparation of a silicone resin, wherein
a. A sulfur containing material
b. A phosphorylated alkoxysilane or hydroxysilane or alkoxy(poly) siloxane or hydroxyl(poly)siloxane
c. Optionally an alkoxysilane or hydroxysilane or alkoxy(poly)siloxane or hydroxyl(poly)siloxane
   are hydrolysed and condensed to form siloxane bonds optionally in the presence of an inorganic filler.

In a possible synthesis approach, the alkoxypolysiloxane or hydroxypolysiloxane resins can be used as raw material. A branched silicone resin of the invention containing at least one phosphorus containing moiety present in a T unit of the formula R_{P}SiO_{3/2} can for example be prepared by a process in which a trialkoxysilane of the formula R_{P}Si(OR′)₃ is hydrolysed and condensed with sulfur containing compound. Examples of useful trialkoxysilanes containing a R_{P} group are 2-(diethylphosphonato)ethyltriethoxysilane, 3-(diethylphosphonato)propyltriethoxysilane and 2-(DOPO)ethyltriethoxysilane.

A silicone resin of the invention containing at least one organic nitrogen-containing group present in a T unit of the formula R_{N}SiO_{3/2} can for example be prepared by a process in which a trialkoxysilane of the formula R_{N}Si(OR′)₃ is hydrolysed and condensed with a Sulfur-containing compound. Examples of useful trialkoxysilanes containing a R_{N} group are

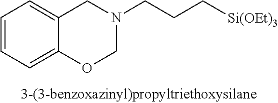

and the corresponding naphthoxazinetriethoxysilane,

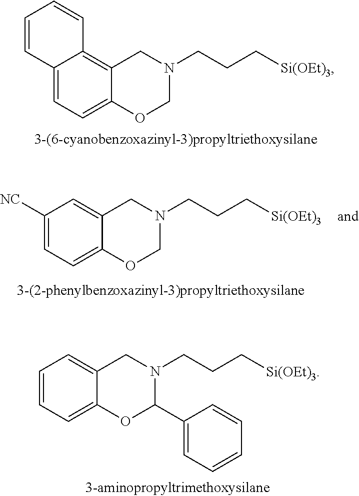

The branched silicone resin containing at least one organic nitrogen-containing group can be formed from a bis(alkoxysilane), for example a bis(trialkoxysilane), containing two heterocyclic rings each having an alkoxysilane substituent, such as 1,3-bis(3-(3-trimethoxysilylpropyl)benzoxazinyl-6)-2,2-dimethylpropane

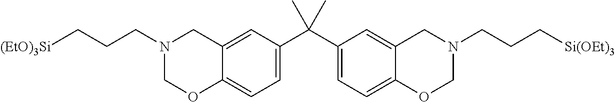

The silicone resin can in one preferred embodiment comprises mainly T units, that is at least 50 mole % T units, and more preferably at least 80 or 90% T units. It can for example comprise substantially all T units.

The trialkoxysilanes or trihydroxysilane of the formulae R_{P}Si(OR′)₃ and R_{N}Si(OR′)₃ can be hydrolysed and condensed in the presence of a Sulfur-containing containing material, optionally with an hydroxysilane or alkoxysilane of the formula R⁴Si(OR′)₃, in which each R′ is an hydrogen, alkyl group having 1 to 4 carbon atoms and R⁴ represents a hydrogen, alkyl, cycloalkyl, aminoalkyl, alkenyl, alkynyl, aryl or aminoaryl group having 1 to 20 carbon atoms. Examples of useful alkoxysilanes of the formula R⁴Si(OR′)₃ are alkyltrialkoxysilanes such as methyltriethoxysilane, ethyltriethoxysilane, methyltrimethoxysilane, aryltrialkoxysilanes such as phenyltriethoxysilane and alkenyltrialkoxysilanes such as vinyltrimethoxysilane.

Alternative alkoxysilanes or hydroxysilanes containing a phosphorus group are monoalkoxysilanes for example of the formula R_{P}R¹¹₂SiOR′ and dialkoxysilanes for example of the formula R_{P}R¹¹Si(OR′)₂, where each R′ is a hydrogen, alkyl group having 1 to 4 carbon atoms; each R_{P} is an alkyl, cycloalkyl, alkenyl, alkynyl or aryl group having 1 to 20 carbon atoms containing a phosphorous substituent, preferably a phosphonate or phosphinate substituent; and each R¹¹ which can be the same or different is an alkyl, cycloalkyl, alkenyl, alkynyl or aryl group having 1 to 20 carbon atoms or an alkyl, cycloalkyl, alkenyl, alkynyl or aryl group having 1 to 20 carbon atoms containing a phosphorous substituent, preferably a phosphonate or phosphinate substituent. Examples of suitable monoalkoxysilanes containing a phosphonate or phosphinate group are 2-(DOPO)ethyldimethylethoxysilane and 3-(diethylphosphonato)propyldimethylethoxysilane. Examples of suitable dialkoxysilanes containing a phosphonate or phosphinate group are 2-(DOPO)ethylmethyldiethoxysilane and 3-(diethylphosphonato)propylmethyldiethoxysilane.

Alternative alkoxysilanes or hydroxysilanes containing an organic nitrogen-containing group are monoalkoxysilanes for example of the formula R_{N}R¹²₂SiOR′ and dialkoxysilanes for example of the formula R_{N}R¹²Si(OR′)₂ where each R_{N} is an alkyl, cycloalkyl, alkenyl, alkynyl or aryl group having 1 to 20 carbon atoms containing an organic nitrogen substituent; and each R¹² which can be the same or different is an alkyl, cycloalkyl, alkenyl, alkynyl or aryl group having 1 to 20 carbon atoms or an alkyl, cycloalkyl, alkenyl, alkynyl or aryl group having 1 to 20 carbon atoms containing an organic nitrogen substituent. Examples of suitable monoalkoxysilanes containing an organic nitrogen substituent are 3-(3-benzoxazinyl)propyldimethylethoxysilane and 3-aminopropyldimethylethoxysilane. Examples of suitable dialkoxysilanes containing an organic nitrogen substituent are 3-(3-benzoxazinyl)propylmethyldiethoxysilane and 3-aminopropylmethyldimethoxysilane.

Monoalkoxysilanes or hydroxysilanes when hydrolysed and condensed will form M groups in the silicone resin and dialkoxysilanes when hydrolysed and condensed will form D groups in the silicone resin. A monoalkoxysilane or dialkoxysilane containing a R_{P} group can be reacted with trialkoxysilanes and/or tetraalkoxysilanes to form a branched silicone resin.

In preferred embodiment, the reactant is alkoxysilane, alkoxypolysiloxane or hydroxysilane or hydroxypolysiloxane. The optionally present alkoxysilane or hydroxysilane is preferably selected from i) tetra(alkoxysilane) Si(OR3)4, (ii) trialkoxysilane R6Si(OR3)3, (iii) dialkoxysilane R6R7Si(OR3)2 or (iv) monoalkoxysilane R6R7R8SiOR3, a mixture containing two or more of (i), (ii), (iii) or (iv), where R3 is a C1 to C10 alkyl group and R6, R7 and R8 are independently alkyl, alkenyl, aryl, arylalkyl, bearing or not organic functionalities such as but not limited to glycidoxy, methacryloxy, acryloxy, and R is an alkyl group. Example of suitable hydroxysilane is diphenyl(dihydroxy)silane.

The sulfur-containing material used as sulfur reactant can be for example thiourea or a thiol. It can be a sulfur containing silane like thiopropylsilane, TESPT (bis-[3-(Triethoxysilyl) propyl]-tetrasulphide) or 2-(4-Chlorosulfonylphenyl)ethyltrimethoxysilane. It can be sulfuric acid which can be later mixed with a phosphorylated silicone resin, In another embodiment, the sulfur reactant is Cl2SO2, Cl2SO, ammonium sulfamate, the family of mercaptosilanes and silthianes (linear or cyclic).

Production of sulfonylated resin can be obtained through reaction of aminated alkoxysilane like gamma aminopropyltriethoxysilane and sulfonyl reactant like paratoluenesulfonyl chloride for example in the presence of CaCO3 in ethanol. The corresponding sulfonylated silane could be used as it is or introduced in a resin. This molecule would also bring nitrogen in the material, which is a foaming source. The phenyl ring increases compatibility to the polymer matrix wherein the silicone resin is put.

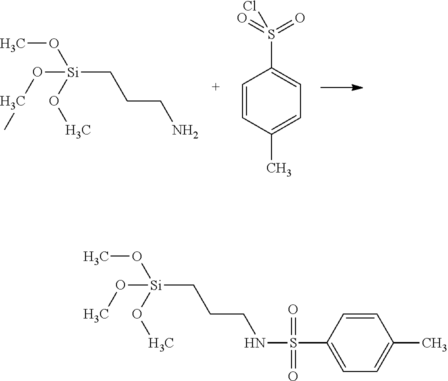

A useful sulfonylated salt can be produced by reacting phenylsilane with H2SO4 followed by water washings and K2CO3 treatment. The reaction is then:

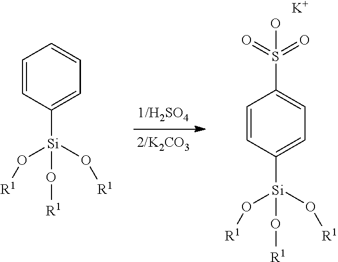

In some preferred embodiments, the silicone resin contains together phosphorus, nitrogen and sulfur.

Addition of water during the synthesis is possible but not required. Water loading are calculated minimum to consume partially the alkoxies and preferably the whole alkoxies present in the system.

Preferably, the whole mixture is refluxed at a temperature preferably ranging from 50 to 160° C. in the presence or not of an organic solvent. Then the alcohol and organic solvent are stripped and possible remaining water are distilled off from the resin through, for example, azeotropic mixture water/alcohol.

These new phosphorylated Sulfur-containing siloxanes don't systematically require any condensation catalyst to condense, which represent an advantage in terms of processing as no filtration step is required to remove possible condensation catalyst from the media.

In some preferred embodiments, a condensation catalyst is used during the synthesis to force/increase conversion. For example, HCl or Sn or Ti based catalytic systems can be used. The obtained product can be further dried under vacuum at high temperature (ranging from 50 to 100° C.) to remove remaining traces of solvents, alcohols or water.

These phosphorylated siloxanes demonstrate better heat stability compared to their non-phosphorylated resins counterparts. These resins can be used as additives in polymers or coatings formulations to improve, for example, flame retardancy and/or scratch and/or abrasion resistance.

These new resins can be further blended with various thermoplastic or thermosetting organic polymer or any blends of the laters or rubber or thermoplastic/rubber blends to make them flame retardant. The invention therefore extends to the use of the silicone resin in a thermoplastic or thermosetting organic polymer or blend of thermoplastic or thermosetting organic polymer or rubbers or thermoplastic/rubbers blends composition to reduce the flammability or enhance scratch and/or abrasion resistance of composition.

The invention provides a process for improving the fire resistance and/or the scratch and/or abrasion resistance of a polymeric matrix characterised in that a silicone resin according to any preceding claim is added to a polymer composition.

The polymer matrix composition can be an already polymerised composition or a monomer composition wherein the resin is added. In the latter case, the resin can be if needed modified beforehand to become reactive with the monomer composition so as to form a copolymer. For example a silicone resin according to the invention can be reacted with eugenol to provide terminal —OH bonds. The modified resin can then be reacted with bisphenol-A and phosgene to provide a Si—O-M-polycarbonate copolymer.

The invention allows a reduction of the emitted fumes upon burning compared to their non phosphorylated and/or non nitrogenated counterparts. The invention keeps to a certain extent the transparency of the host matrix, i.e. the new resin allows to keep the transparency of the polymer it is blended with or the coating made up with the resin is transparent.

The silicone resins of the invention have a high thermal stability which is higher than that of their non-phosphorylated or non-nitrogenated counterparts and higher than that of linear silicone polymers. This higher thermal stability is due to the presence of phosphorus or nitrogen atom that leads to the formation of highly stable ceramic structures. Such silicone resins additionally undergo an intumescent effect on intense heating, forming a flame resistant insulating char.

The branched silicone resins of the invention can be blended with a wide range of thermoplastic resins, for example polycarbonates, polyamides, ABS (acrylonitrile butadiene styrene) resins, polycarbonate/ABS blends, polyesters, polystyrene, or polyolefins such as polypropylene or polyethylene. The silicone resins of the invention can also be blended with thermosetting resins, for example epoxy resins of the type used in electronics applications, which are subsequently thermoset, or unsaturated polyester resin. The mixtures of thermoplastics or thermosets with the silicone resins of the invention as additives should have a low impact on Tg value and thermal stability, as shown by differential scanning calorimetry (DSC) and thermogravimetric analysis (TGA), and better flammability properties, as shown by UL-94 test, and/or other flammability tests such as the glow wire test or cone calorimetry, compared to their non phosphorylated counterparts.

The thermoplastic polymer can be chosen from the carbonate family (e.g. Polycarbonate PC), polyamides (e.g. Polyamide 6 and 6.6), polyesters (e.g. polyethyleneterephtalate). The thermoplastic polymer can be chosen from the polyolefin family (e.g. polypropylene PP or polyethylene PE). The thermoplastic resin can be a bio-sourced thermoplastic matrice such as polylactic acid (PLA) or polyhydroxybutadiene (PHB) or bio-sourced PP or PE. The polymer can be chosen from thermoplastic/rubbers blends from the family of PC/Acrylonitrile/styrene/butadiene ABS. The polymer can be a PBT Polybutylene terephtalate polymer.

The polymer can be chosen from rubber made of a diene, preferably natural rubber. The polymer can be chosen from thermoset from the Novolac family (phenol-formol) or epoxy resin. These above polymers can optionally be reinforced with, for example, glass fibres. Applications include but are not limited to transportation vehicles, construction, electrical application, printed circuits boards and textiles. Unsaturated polyester resins, or epoxy are moulded for use in, for example, the nacelle of wind turbine devices. Normally, they are reinforced with glass (or carbon) fibre cloth; however, the use of a flame retardant additive is important for avoiding fire propagation.

The silicone resins of the invention frequently have further advantages including but not limited to transparency, higher impact strength, toughness, increased adhesion between two surfaces, increased surface adhesion, scratch and/or abrasion resistance and improved tensile and flexural mechanical properties. The resins can be added to polymer compositions to improve mechanical properties such as impact strength, toughness and tensile, flexural mechanical properties and scratch and/or abrasion resistance. The resins can be used to treat reinforcing fibres used in polymer matrices to improve adhesion at the fibre polymer interface. Examples of fibres include natural fibres such as wood flour, wood fibres, cotton fibres, cellulosic fibres or agricultural fibres such as wheat straw, hemp, flax, kenaf, kapok, jute, ramie, sisal, henequen, corn fibre or coir, or nut shells or rice hulls, or synthetic fibres such as polyester fibres, aramid fibres, nylon fibres, or glass fibres. The resins can be used at the surface of polymer compositions to improve adhesion to paints. The resins can be used to form coatings on a substrate.

The silicone resins of the invention can for example be present in thermoplastic or thermoset or any blends of the latter or rubber or thermoplastic/rubber blends organic polymer compositions in amounts ranging from 0.1 or 0.5% by weight up to 50 or 75%. Preferred amounts may range from 0.1 to 25% by weight silicone resin in thermoplastic compositions such as polycarbonates, and from 0.2 to 75% by weight in thermosetting compositions such as epoxy resins.

The invention also provides the use of a silicone resin as defined herein above as a fire- or scratch- and/or abrasion resistant coating on a substrate. The invention further provides a thermoplastic or a thermoplastic or thermoset blend or thermoset or rubber or thermoplastic/rubber blends organic polymer composition comprising a thermoplastic or thermoset organic polymer and a silicone resin as defined herein above.

The invention also provides a fire- or scratch and/or abrasion resistant coating on a substrate wherein the coating comprises a silicone resin as defined herein above.

In certain preferred embodiments, the silicone resin disclosed in the present patent can be used in conjunction with another flame retardant compound. Among the halogen-free flame retardants one can find the metal hydroxides, such as magnesium hydroxide (Mg(OH)₂) or aluminium hydroxide (Al(OH)₃), which act by heat absorbance, i.e. endothermic decomposition into the respective oxides and water when heated, however they present low flame retardancy efficiency, low thermal stability and significant deterioration of the physical/chemical properties of the matrices due to high loadings. Other compounds act mostly on the condensed phase, such as expandable graphite, organic phosphorous (e.g. phosphate, phosphonates, phosphine, phosphine oxide, phosphonium compounds, phosphites, etc.), ammonium polyphosphate, polyols, etc. Zinc borate, nanoclays and red phosphorous are other examples of halogen-free flame retardants synergists that can be combined with the silicone material disclosed in this patent. Silicon-containing additives such as silica, aluminosilicate or magnesium silicate (talc) are known to significantly improve the flame retardancy, acting mainly through char stabilization in the condensed phase. Silicone-based additives such as silicone gums are known to significantly improve the flame retardancy, acting mainly through char stabilization in the condensed phase. Sulfur-containing additives, such as potassium diphenyl sulfone sulfonate (known as KSS), are well known flame retardant additives for thermoplastics, in particular for polycarbonate but are only of high efficiency at reducing the dripping effect. In a preferred embodiment, the resin is used in conjunction with Zinc-Borate additive.

Either the halogenated, or the halogen-free compounds can act by themselves, or as synergetic agent together with the compositions claimed in the present patent to render the desired flame retardance performance to many polymer or rubber matrices. For instance, phosphonate, phosphine or phosphine oxide have been referred in the literature as being anti-dripping agents and can be used in synergy with the flame retardant additives disclosed in the present patent. The paper “Flame-retardant and anti-dripping effects of a novel char-forming flame retardant for the treatment of poly(ethylene terephthalate) fabrics” presented by Dai Qi Chen et al. at 2005 Polymer Degradation and Stability describes the application of a phosphonate, namely poly(2-hydroxy propylene spirocyclic pentaerythritol bisphosphonate) to impart flame retardance and dripping resistance to poly(ethylene terephthalate) (PET) fabrics. Benzoguanamine has been applied to PET fabrics to reach anti-dripping performance as reported by Hong-yan Tang et al. at 2010 in “A novel process for preparing anti-dripping polyethylene terephthalate fibres”, Materials & Design. The paper “Novel Flame-Retardant and Anti-dripping Branched Polyesters Prepared via Phosphorus-Containing Ionic Monomer as End-Capping Agent” by Jun-Sheng Wang et al. at 2010 reports on a series of novel branched polyester-based ionomers which were synthesized with trihydroxy ethyl esters of trimethyl-1,3,5-benzentricarboxylate (as branching agent) and sodium salt of 2-hydroxyethyl 3-(phenylphosphinyl)propionate (as end-capping agent) by melt polycondensation. These flame retardant additives dedicated to anti-dripping performance can be used in synergy with the flame retardant additives disclosed in this patent. Additionally, the flame retardant additives disclosed in the present patent may have synergy with other well-known halogen-free additives, such as Zinc Borates and Metal Hydroxydes (aluminium trihydroxyde or magnesium dihydroxyde) or polyols (pentaerythritol). When used as synergists, classical flame retardants such as Zinc Borates or Metal Hydroxydes (aluminium trihydroxyde or Magnesium dihydroxyde) can be either physically blended or surface pre-treated with the silicon based additives disclosed in this patent prior to compounding.

Therefore, preferably the thermoplastic or thermoset organic polymer composition according to the invention further comprises classical flame retardant additive such as but not limited to inorganic flame retardants such as metal hydrates or zinc borates, magnesium hydroxide, aluminum hydroxide, phosphorus and/or nitrogen containing additives such as ammonium polyphosphate, boron phosphate, carbon based additives such as expandable graphite or carbon nanotubes, nanoclays, red phosphorous, silica, aluminosilicates or magnesium silicate (talc), silicone gum, sulfur based additives such as sulfonate, ammonium sulfamate, potassium diphenyl sulfone sulfonate (KSS) or thiourea derivatives, polyols like pentaerythritol, dipentaerythritol, tripentaerythritol or polyvinylalcohol.

Examples of mineral fillers or pigments which can be incorporated in the polymer include titanium dioxide, aluminium trihydroxide, magnesium dihydroxide, mica, kaolin, calcium carbonate, non-hydrated, partially hydrated, or hydrated fluorides, chlorides, bromides, iodides, chromates, carbonates, hydroxides, phosphates, hydrogen phosphates, nitrates, oxides, and sulphates of sodium, potassium, magnesium, calcium, and barium; zinc oxide, aluminium oxide, antimony pentoxide, antimony trioxide, beryllium oxide, chromium oxide, iron oxide, lithopone, boric acid or a borate salt such as zinc borate, barium metaborate or aluminium borate, mixed metal oxides such as aluminosilicate, vermiculite, silica including fumed silica, fused silica, precipitated silica, quartz, sand, and silica gel; rice hull ash, ceramic and glass beads, zeolites, metals such as aluminium flakes or powder, bronze powder, copper, gold, molybdenum, nickel, silver powder or flakes, stainless steel powder, tungsten, hydrous calcium silicate, barium titanate, silica-carbon black composite, functionalized carbon nanotubes, cement, fly ash, slate flour, bentonite, clay, talc, anthracite, apatite, attapulgite, boron nitride, cristobalite, diatomaceous earth, dolomite, ferrite, feldspar, graphite, calcined kaolin, molybdenum disulfide, perlite, pumice, pyrophyllite, sepiolite, zinc stannate, zinc sulfide or wollastonite. Examples of fibres include natural fibres such as wood flour, wood fibres, cotton fibres, cellulosic fibres or agricultural fibres such as wheat straw, hemp, flax, kenaf, kapok, jute, ramie, sisal, henequen, corn fibre or coir, or nut shells or rice hulls, or synthetic fibres such as polyester fibres, aramid fibres, nylon fibres, or glass fibres. Examples of organic fillers include lignin, starch or cellulose and cellulose-containing products, or plastic microspheres of polytetrafluoroethylene or polyethylene. The filler can be a solid organic pigment such as those incorporating azo, indigoid, triphenylmethane, anthraquinone, hydroquinone or xanthine dyes.

DOPO-Silane refers to the following structure:

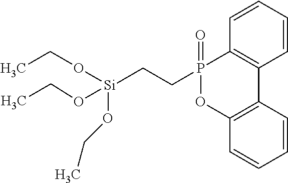 [SMILES: CCO[Si](CCP1(=O)Oc2ccccc2-c2ccccc21)(OCC)OCC]

### PROPHETIC EXAMPLE

2-DOPO-ethyl triethoxysilane referred to the structure above.

### Synthesis of T(DOPO)50T(S)50 Resin

In a round bottomed reactor equipped with a vapor condenser system, a double jacketing heat control system and flushed with N2 blanketing, 169.33 gr of 3-mercapto trimethoxysilane (1 mol), 406 gr of 2-DOPO-ethyl trimethoxysilane will be mixed together with 36 gr distilled water (2eq), heated-up to 100° C. and refluxed for 4 hours. The formed alcohol (Methanol and ethanol) will be removed under vacuum at 50° C. to afford a viscous concentrated resin which will be discharged in a container. The container will be placed a vacuum oven and residual solvent will be stripped at 100° C. to afford T(DOPO)50T(S)50 resin as a whitish solid.

The obtained powder will be processed as follows:

| Material to introduce | Time (min) |
|---|---|
| Chamber T° 270° C., Blade at 50 rotations per minute - | 0.0 |
| add ⅓ of PC resin and close ramp | |
| Add ⅓ of PC resin and after the peak torque close the ramp | 2.0 |
| Add the Si-based material, close the ramp and set the | 3.0 |
| temperature to 260° C. | |
| Add ⅓ of PC resin, set the rotation to 70 RPM and leave | 4.0 |
| the ramp open | |
| close the ramp | 5.0 |
| Drop Batch | 7.0 |

Material will be compression moulded into 100×100×3 mm plates. These plates will be used to run thermal characterization as cone calorimeter test.

1. A silicone resin comprising:
at least one group comprising sulphur; and
at least one group comprising phosphorus, and optionally, nitrogen.

2. The silicone resin according to claim 1, comprising T units; D units; M units and/or Q units.

3. The silicone resin according to claim 1, comprising at least one phosphine and/or phosphine oxide and/or phosphinate and/or phosphinite and/or phosphonite and/or phosphite, and/or phosphonate and/or phosphate moiety present in a M unit of the formula RPR2SiO1/2 and/or D unit of the formula RPRSiO2/2 and/or a T unit of the formula RPSiO3/2, where RP is an alkyl, cycloalkyl, alkenyl, alkynyl or aryl group having 1 to 20 carbon atoms containing a phosphine and/or phosphine oxide and/or phosphinate and/or phosphinite and/or phosphonite and/or phosphite, and/or phosphonate and/or phosphate substituent, and each group R is independently an alkyl, cycloalkyl, alkenyl, alkynyl or aryl group having 1 to 20 carbon atoms.

4. The silicone resin according to claim 3, wherein the phosphine and/or phosphine oxide and/or phosphinate and/or phosphinite and/or phosphonite and/or phosphite, and/or phosphonate and/or phosphate is present in a T unit of the formula RPSiO3/2.

5. The silicone resin according to claim 3, wherein the group RP has the formula 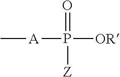
where A is a divalent hydrocarbon group having 1 to 20 carbon atoms or a —OR*, where R* is an hydrogen, alkyl or aryl group having 1 to 12 carbon atoms, and Z is a group of the formula —OR* or an alkyl, cycloalkyl, alkenyl, alkynyl or aryl group having 1 to 20 carbon atoms, and provided when 2 —OR* are present, R* can be the same or different.

6. The silicone resin according to claim 3, wherein the group RP has the formula 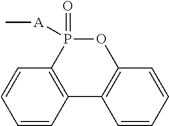
where A is a divalent hydrocarbon group having 1 to 20 carbon atoms.

7. The silicone resin according to claim 1, wherein the sulfur is at an oxidation state of −2, −1, 1, 2, 3, 4, 5, or 6.

8. The silicone resin according to claim 1 wherein the molar ratio of sulfur atom to Si atom ranges from 0.01 to 2.

9. A method for the preparation of a silicone resin according to claim 1, wherein:
a material comprising sulfur; and
phosphorylated alkoxysilane, phosphorylated hydroxysilane, phosphorylated alkoxy(poly)siloxane, or phosphorylated hydroxyl(poly)siloxane; and
optionally, an alkoxysilane, a hydroxysilane, an alkoxy(poly)siloxane, or a hydroxyl(poly)siloxane;
are hydrolysed and condensed to form siloxane bonds of the silicone resin.

10. A method according to claim 10, wherein the material comprising sulfur is thiosilane, thiourea, bis[3-(triethoxysilyl)propyl]tetrasulfide (TESPT), thionyl chloride, Cl2SO2, Cl2SO, ammonium sulfamate, mercaptosilane, or silthiane.

11. A composition comprising the silicone resin according to claim 1 for reducing the flammability or enhancing the scratch and/or abrasion resistance of the composition.

12. (canceled)

13. A thermoplastic or thermoset organic polymer or a blend of thermoplastic or thermosetting organic polymers or rubbers or thermoplastic/rubbers blends composition comprising a thermoplastic or thermoset organic polymer or rubbers or thermoplastic/rubbers blends and the silicone resin according to claim 1.

14. A thermoplastic or thermoset organic polymer composition according to claim 13, further comprising a flame retardant.

15. A fire- or scratch and/or abrasion resistant coating on a substrate, wherein the coating comprises the silicone resin according to claim 1.

16. A process for improving the fire resistance and/or the scratch and/or abrasion resistance of a polymeric matrix, comprising: adding the silicone resin according to claim 1 to a polymer composition.

17. The silicone resin according to claim 1, wherein the group comprising phosphorus further comprises nitrogen.

18. The silicone resin according to claim 7, comprising a T unit having the group comprising sulfur.

19. The method according to claim 9, wherein the silicone resin is prepared in the presence of a filler, alternatively in the presence of an inorganic filler.

20. The polymer composition according to claim 14, wherein the flame retardant comprises a metal hydrate, zinc borate, magnesium hydroxide, aluminum hydroxide, ammonium polyphosphate, boron phosphate, expandable graphite, carbon nanotubes, nanoclays, red phosphorous, silica, aluminosilicates, magnesium silicate (talc), silicone gum, sulfonate, ammonium sulfamate, potassium diphenyl sulfone sulfonate (KSS), a thiourea derivative, pentaerythritol, dipentaerythritol, tripentaerythritol, polyvinylalcohol, or combinations thereof.
